(19) United States
(12) Patent Application Publication
(10) Pub. No.: US 2025/0081176 A1
(43) Pub. Date: Mar. 6, 2025

(54) SYSTEMS AND METHODS OF TARGET WAKE TIME SCHEDULE MANAGEMENT

(71) Applicant: Meta Platforms Technologies, LLC, Menlo Park, CA (US)

(72) Inventors: Muhammad Kumail Haider, Sunnyvale, CA (US); Guoqing Li, Cupertino, CA (US)

(73) Assignee: Meta Platforms Technologies, LLC, Menlo Park, CA (US)

(21) Appl. No.: 18/796,765

(22) Filed: Aug. 7, 2024

Related U.S. Application Data
(60) Provisional application No. 63/580,867, filed on Sep. 6, 2023.

(51) Int. Cl. H04W 72/12; H04W 84/12

(52) U.S. Cl. CPC H04W 72/12; H04W 84/12

(57) ABSTRACT

Systems, methods, and devices for managing target wake time (TWT) schedules may include a first device of a wireless local area network (WLAN) which receives information relating to drift of a start time of a target wake time (TWT) schedule from a second device of the WLAN. The first device may modify a start time for a subsequent TWT service period, according to the information relating to the drift of the start time from the second device.

### CROSS-REFERENCE TO RELATED APPLICATIONS

This application claims the benefit of and priority to U.S. Provisional Application No. 63/580,867, filed Sep. 6, 2023, the contents of which is incorporated herein by reference in their entirety.

### FIELD OF DISCLOSURE

The present disclosure is generally related to communications, including but not limited to systems and methods for management of schedules for target wake time service periods. For example, the target wake time service periods can be adjusted to align with periodic availability, such as the periodic availability of video data, which corresponds to a refresh rate.

### BACKGROUND

Devices of one or more networks in proximity to one another can enter low power states to reduce energy usage during times of inactivity. Battery operated devices may employ low power states to extend battery life, though lowering energy consumption of all devices can aid in improving efficiency of operation. For example, wireless communication devices can synchronize operational windows to reduce power usage, such as by establishing a target wake times (TWT) in wireless fidelity (Wi-Fi) networks. The Wi-Fi networks can include one or more networks of overlapping basic service sets (OBSSs), for which latency or throughput may depend on inter-network interference, provisioning, or scheduling.

Artificial reality, such as a virtual reality (VR), augmented reality (AR), or mixed reality (MR), provides immersive experience to a user. In one example, a head wearable display (HWD) can display an image of a virtual object generated by a computing device communicatively coupled to the HWD, such as over at least one wireless network. The network can include various peripheral or other devices.

### SUMMARY

In one aspect, this disclosure is directed to a method. The method may include advertising, by a first access point (AP), a first information element (IE) indicating a target wake time (TWT) schedule capability of the first AP. The method may include receiving, by the first AP, from a second AP, a request to establish a TWT schedule coordination agreement according to the TWT schedule capability of the first AP. The method may include transmitting, by the first AP, a second IE to the second AP, the second IE including information indicating a TWT schedule of the first AP.

In some embodiments, the first IE indicates a level of coordination selected from multiple levels of coordination, and wherein the request received from the second AP is according to the level of coordination indicated in the first IE. In some embodiments, the levels of coordination include a first level of coordination corresponding to a scheduling announcement, a second level of coordination corresponding to scheduling alignment, and a third level of coordination corresponding to joint scheduling, and wherein the request received from the second AP is either at the level of coordination indicated by the first IE or below the level of coordination (at a different level). In some embodiments, the method includes receiving, by the first AP, a third IE from the second AP, the third IE including information indicating a TWT schedule of the second AP. In some embodiments, the method includes transmitting, by the first AP, to a service set (SS) of the first AP, one or more signals indicating the TWT schedule of the second AP.

In some embodiments, the first AP and the second AP are a group of APs, and one of the first AP or the second AP includes a group owner AP, and a remainder of the group of APs include group member APs. In some embodiments, the second IE includes a first field for a schedule type for the TWT schedule and a second field for coordination information corresponding to the TWT schedule capability. In some embodiments, the second IE includes a field indicating a count of basic service sets (BSSs) corresponding to the TWT schedule. In some embodiments, the field includes a first field, wherein the second IE includes a second field indicating whether a list of BSSs are included in the second IE. In some embodiments, the second IE further includes, according to a value of the second field, a third field including a list of identifiers corresponding to each of the BSSs which correspond to the TWT schedule. In some embodiments, the second IE includes a TWT element including a subfield which indicates whether the TWT element is for establishing the TWT schedule of the first AP, or for schedule coordination between the first AP and the second AP. In some embodiments, the second IE is included in a TWT schedule coordination frame including a category field, an action field, and the second IE.

In some embodiments, the first device receives the information in an announcement of the TWT schedule from the second device. In some embodiments, the announcement includes at least one of a broadcast frame, the broadcast frame including a beacon response frame or a probe response frame, or an individually addressed frame to the first WLAN device, the individually addressed frame including an individual probe response frame or a re-association response frame. In some embodiments, the information relating to the drift may be received in a message including a TWT element indicating a start time and a wake interval of the TWT schedule.

In another aspect, this disclosure is directed to a first access point (AP). The first AP may include a wireless transceiver and one or more processors. The one or more processors are configured to advertise a first information element (IE) indicating a target wake time (TWT) schedule capability of the first AP. The one or more processors are configured to receive, from a second AP, a request to establish a TWT schedule coordination agreement according to the TWT schedule capability of the first AP. The one or more processors are configured to transmit a second IE to the second AP, the second IE including information indicating a TWT schedule of the first AP.

In some embodiments, the first IE indicates a level of coordination selected from a plurality of levels of coordination and the request received from the second AP is according to the level of coordination indicated in the first IE. In some embodiments, the levels of coordination include a first level of coordination corresponding to a scheduling announcement, a second level of coordination corresponding to scheduling alignment, and a third level of coordination corresponding to joint scheduling. The request received from the second AP can be either at the level of coordination indicated by the first IE or at a different level below the level of coordination.

In some embodiments, the one or more processors are configured to receive a third IE from the second AP, the third IE including information indicating a TWT schedule of the second AP and transmit, to a service set (SS) of the first AP, one or more signals indicating the TWT schedule of the second AP. In some embodiments, the first AP and the second AP are a group of APs. One of the first AP or the second AP can include a group owner AP, and a remainder of the group of APs can include group member APs. In some embodiments, the second IE includes a first field for a schedule type for the TWT schedule and a second field for coordination information corresponding to the TWT schedule capability.

In some embodiments, the second IE includes a field indicating a count of basic service sets (BSSs) corresponding to the TWT schedule. In some embodiments, the field includes a first field, wherein the second IE includes a second field indicating whether a list of BSSs are included in the second IE, and wherein the second IE further includes, according to a value of the second field, a third field including a list of identifiers corresponding to each of the BSSs which correspond to the TWT schedule. In some embodiments, the second IE includes a TWT element including a subfield which indicates whether the TWT element is for establishing the TWT schedule of the first AP, or for schedule coordination between the first AP and the second AP. In some embodiments, the information relating to the drift is transmitted in a message including a TWT element indicating a start time and a wake interval of the TWT schedule.

In another aspect, this disclosure is directed to a first access point (AP). The first AP may include a wireless transceiver and one or more processors. The one or more processors are configured to receive an advertisement of a first information element (IE) indicating a target wake time (TWT) schedule capability of a second AP. The one or more processors are configured to transmit to the second AP, responsive to the receipt of the first information element (IE), a request to establish a TWT schedule coordination agreement according to the TWT schedule capability of the second AP. The one or more processors are configured to receive a second IE from the second AP, the second IE including information indicating a TWT schedule of the second AP.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a timing diagram showing a wake-up/sleep schedule of a computing device utilizing TWT, according to an example implementation of the present disclosure.

FIG. 5 is a diagram showing an example field to convey target wake time coordination information between access points of overlapping basic services sets, according to an example implementation of the present disclosure.

FIG. 6 is another diagram showing an example field to convey target wake time coordination information between access points of overlapping basic services sets, according to an example implementation of the present disclosure.

FIG. 7 is a diagram showing an example field to convey target wake time information between various networked devices, according to an example implementation of the present disclosure.

FIG. 8 is another diagram showing an example field to convey target wake time information between various networked devices, according to an example implementation of the present disclosure.

FIG. 9 is yet another diagram showing an example field to convey target wake time information between various networked devices, according to an example implementation of the present disclosure.

FIG. 10 is a further diagram still, showing an example field to convey target wake time information between various networked devices, according to an example implementation of the present disclosure.

FIG. 11 is a block diagram of a computing environment, according to an example implementation of the present disclosure.

FIG. 12 is an interaction diagram showing a method of forming and managing TWT groups, according to an example implementation of the present disclosure.

FIG. 13 is a flowchart showing a method of establishment of at least one TWT schedule coordination group, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

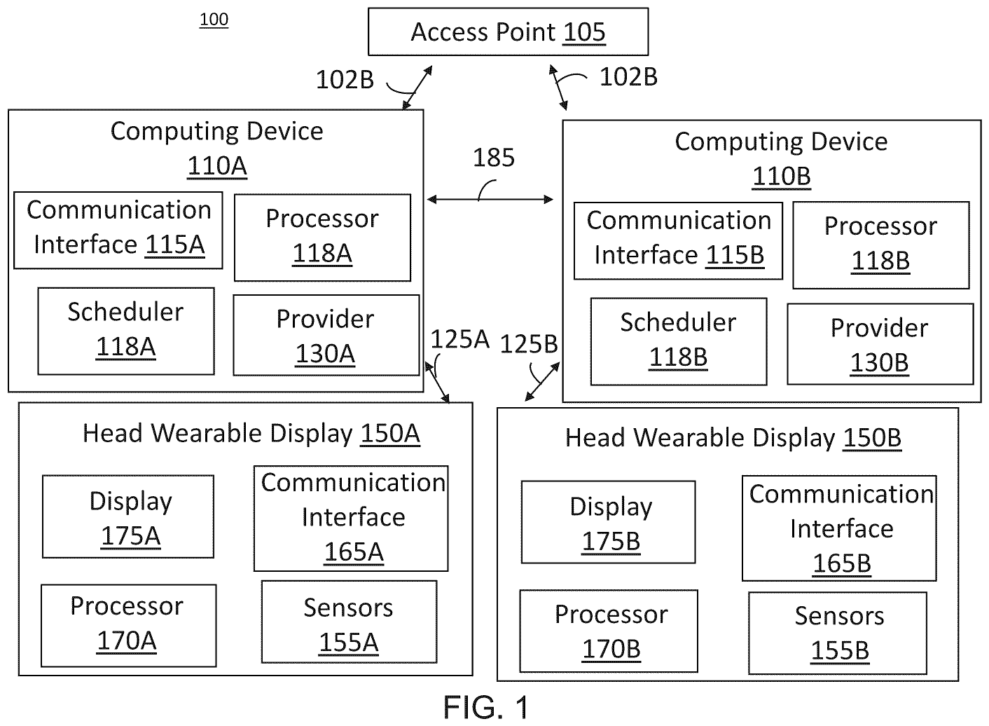

FIG. 1 is a block diagram of an example artificial reality system environment. FIG. 1 provides an example environment in which devices may communicate traffic streams with different latency sensitivities/requirements. In some embodiments, the artificial reality system environment 100 includes an access point (AP) 105, one or more head wearable displays (HWD) 150 (e.g., HWD 150A, 150B) worn by a user, and one or more computing devices 110 (computing devices 110A, 110B) providing content of artificial reality to the HWDs 150.

The access point 105 may be a router or any network device allowing one or more computing devices 110 and/or one or more HWDs 150 to access a network (e.g., the Internet).

The access point 105 may be replaced by any communication device (cell site). A HWD may be referred to as, include, or be part of a head mounted display (HMD), head mounted device (HMD), head wearable device (HWD), head worn display (HWD), or head worn device (HWD). In one aspect, the HWD 150 may include various sensors to detect a location, an orientation, and/or a gaze direction of the user wearing the HWD 150, and provide the detected location, orientation and/or gaze direction to the computing device 110 through a wired or wireless connection. The HWD 150 may also identify objects (e.g., body, hand face).

In some embodiments, the computing devices 110A, 110B communicate with the access point 105 through communication links 102A, 102B (e.g., interlinks), respectively. In some embodiments, the computing device 110A may communicate with the HWD 150A through a communication link 125A (e.g., intralink), and the computing device 110B may communicate with the HWD 150B through a wireless link 125B (e.g., intralink).

The computing device 110 may be a computing device or a mobile device that can retrieve content from the access point 105, and can provide image data of artificial reality to a corresponding HWD 150. Each HWD 150 may present the image of the artificial reality to a user according to the image data.

The computing device 110 may determine a view within the space of the artificial reality corresponding to the detected location, orientation and/or the gaze direction, and generate an image depicting the determined view detected by the HWD 150s. The computing device 110 may also receive one or more user inputs and modify the image according to the user inputs. The computing device 110 may provide the image to the HWD 150 for rendering. The image of the space of the artificial reality corresponding to the user's view can be presented to the user.

In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the computing device 110 may be performed by the HWD 150, and/or some of the functionality of the HWD 150 may be performed by the computing device 110. In some embodiments, the computing device 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155 (e.g., sensors 155A, 155B) including eye trackers and hand trackers for instance, a communication interface 165 (e.g., communication interface 165A, 165B), an electronic display 175, and a processor 170 (e.g., processor 170A, 170B). These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, hand trackers, eye trackers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the sensors 155 may also include eye trackers with electronic components or a combination of electronic components and software components that determine a gaze direction of the user of the HWD 150. In other embodiments, the eye trackers may be a component separate from sensors 155. In some embodiments, the HWD 150, the computing device 110 or a combination may incorporate the gaze direction of the user of the HWD 150 to generate image data for artificial reality. In some embodiments, the eye trackers (as part of the sensors 155, for instance) include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is-10 degrees (or 350 degrees) with respect to the HWD 150, the eye trackers may determine that the gaze direction of the user is 20 degrees from the reference direction. In some embodiments, a user of the HWD 150 can configure the HWD 150 (e.g., via user settings) to enable or disable the eye trackers as part of the sensors 155. In some embodiments, a user of the HWD 150 is prompted to enable or disable the eye trackers as part of the sensor 155 configuration.

In some embodiments, the sensors 155 include the hand tracker, which includes an electronic component or a combination of an electronic component and a software component that tracks a hand of the user. In other embodiments, the hand tracker may be a component separate from sensors 155. In some embodiments, the hand tracker includes or is coupled to an imaging sensor (e.g., camera) and an image processor that can detect a shape, a location and/or an orientation of the hand. The hand tracker may generate hand tracking measurements indicating the detected shape, location and/or orientation of the hand.

In some embodiments, the communication interfaces 165 (e.g., communication interface 165A, 165B) of the corresponding HWDs 150 (e.g., HWD 150A, 150B) and/or communication interfaces 115 (e.g., communication interface 115A, 115B) of the corresponding computing devices (e.g., computing device 110A, 110B) include an electronic component or a combination of an electronic component and a software component that is used for communication.

The communication interface 165 may communicate with a communication interface 115 of the computing device 110 through an intralink communication link 125 (e.g., communication link 125A, 125B). The communication interface 165 may transmit to the computing device 110 sensor measurements indicating the determined location of the HWD 150, orientation of the HWD 150, the determined gaze direction of the user, and/or hand tracking measurements. For example, the computing device 110 may receive sensor measurements indicating location and the gaze direction of the user of the HWD 150 and/or hand tracking measurements and provide the image data to the HWD 150 for presentation of the artificial reality, for example, through the wireless link 125 (e.g., intralink). For example, the communication interface 115 may transmit to the HWD 150 data describing an image to be rendered. The communication interface 165 may receive from the computing device 110 sensor measurements indicating or corresponding to an image to be rendered. In some embodiments, the HWD 150 may communicate with the access point 105.

Similarly, the communication interface 115 (e.g., communication interface 115A, 115B) of the computing devices 110 may communicate with the access point 105 through a communication link 102 (e.g., communication link 102A, 102B). In certain embodiments, the computing device 110 may be considered a soft access point (e.g., a hotspot device). Through the communication link 102 (e.g., interlink), the communication interface 115 may transmit and receive from the access point 105 AR/VR content. The communication interface 115 of the computing device 110 may also communicate with communication interface 115 of a different computing device 110 through communication link 185. As described herein, the communication interface 115 may be a counterpart component to the communication interface 165 to communicate with a communication interface 115 of the computing device 110 through a communication link (e.g., USB cable, a wireless link).

The communication interfaces 115 and 165 may receive and/or transmit information indicating a communication link (e.g., channel, timing) between the devices (e.g., between the computing devices 110A and 110B across communication link 185, between the HWD 150A and computing device 110A across communication link 125). According to the information indicating the communication link, the devices may coordinate or schedule operations to avoid interference or collisions.

The communication link may be a wireless link, a wired link, or both. In some embodiments, the communication interface 165/115 includes or is embodied as a transceiver for transmitting and receiving data through a wireless link. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the computing device 110 and the head wearable display 150 are implemented on a single system, the communication interface 165 may communicate with the computing device 110 through a bus connection or a conductive trace.

Using the communication interface, the computing device 110 (or HWD 150, or AP 105) may coordinate operations on links 102, 185 or 125 to reduce collisions or interferences by scheduling communication. For example, the computing device 110 may coordinate communication between the computing device 110 and the HWD 150 using communication link 125. Data (e.g., a traffic stream) may flow in a direction on link 125. For example, the computing device 110 may communicate using a downlink (DL) communication to the HWD 150 and the HWD 150 may communicate using an uplink (UL) communication to the computing device 110. In some implementations, the computing device 110 may transmit a beacon frame periodically to announce/advertise a presence of a wireless link between the computing device 110 and the HWD 150 (or between HWDs 150A and 150B). In an implementation, the HWD 150 may monitor for or receive the beacon frame from the computing device 110, and can schedule communication with the HWD 150 (e.g., using the information in the beacon frame, such as an offset value) to avoid collision or interference with communication between the computing device 110 and/or HWD 150 and other devices.

In some embodiments, the processor 170 may include an image renderer, for instance, which includes an electronic component or a combination of an electronic component and a software component that generates one or more images for display, for example, according to a change in view of the space of the artificial reality. In some embodiments, the image renderer is implemented as processor 170 (or a graphical processing unit (GPU), one or more central processing unit (CPUs), or a combination of them) that executes instructions to perform various functions described herein. In other embodiments, the image renderer may be a component separate from processor 170. The image renderer may receive, through the communication interface 165, data describing an image to be rendered, and render the image through the electronic display 175. In some embodiments, the data from the computing device 110 may be encoded, and the image renderer may decode the data to generate and render the image. In one aspect, the image renderer receives the encoded image from the computing device 110, and decodes the encoded image, such that a communication bandwidth between the computing device 110 and the HWD 150 can be reduced.

In some embodiments, the image renderer receives, from the computing device, 110 additional data including object information indicating virtual objects in the artificial reality space and depth information indicating depth (or distances from the HWD 150) of the virtual objects. Accordingly, the image renderer may receive from the computing device 110 object information and/or depth information. The image renderer may also receive updated sensor measurements from the sensors 155. The process of detecting, by the HWD 150, the location and the orientation of the HWD 150 and/or the gaze direction of the user wearing the HWD 150, and generating and transmitting, by the computing device 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer may generate a small portion (e.g., 10%) of an image corresponding to an updated view within the artificial reality according to the updated sensor measurements, and append the portion to the image in the image data from the computing device 110 through reprojection. The image renderer may perform shading and/or blending on the appended edges. Hence, without recreating the image of the artificial reality according to the updated sensor measurements, the image renderer can generate the image of the artificial reality.

In other implementations, the image renderer generates one or more images through a shading process and a reprojection process when an image from the computing device 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the processor 170 (e.g., image renderer).

In some embodiments, the HWD 150 may include a lens to allow the user to see the display 175 in a close proximity. The lens may be a mechanical component that alters received light from the electronic display 175. The lens may magnify the light from the electronic display 175, and correct for optical error associated with the light. The lens may be a Fresnel lens, a convex lens, a concave lens, a filter, or any suitable optical component that alters the light from the electronic display 175. Through the lens, light from the electronic display 175 can reach the pupils, such that the user can see the image displayed by the electronic display 175, despite the close proximity of the electronic display 175 to the eyes.

In some embodiments, the processor 170 performs compensation to compensate for any distortions or aberrations. In some embodiments, a compensator may be a device separate from the processor 170. The compensator includes an electronic component or a combination of an electronic component and a software component that performs compensation. In one aspect, the lens introduces optical aberrations such as a chromatic aberration, a pin-cushion distortion, barrel distortion, etc. The compensator may determine a compensation (e.g., predistortion) to apply to the image to be rendered from the image renderer to compensate for the distortions caused by the lens, and apply the determined compensation to the image from the image renderer. The compensator may provide the pre-distorted image to the electronic display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a communication interface 115, a processor 118, and a content provider 130 (e.g., content provider 130A, 130B). These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view.

The processors 118, 170 includes or is embodied as one or more central processing units, graphics processing units, image processors, or any processors for generating images of the artificial reality. In some embodiments, the processors 118, 170 may configure or cause the communication interfaces 115, 165 to toggle, transition, cycle or switch between a sleep mode and a wake-up mode. In the wake-up mode, the processor 118 may enable the communication interface 115 and the processor 170 may enable the communication interface 165, such that the communication interfaces 115, 165 may exchange data. In the sleep mode, the processor 118 may disable the wireless interface 115 and the processor 170 may disable (e.g., may implement low power or reduced operation in) the communication interface 165, such that the communication interfaces 115, 165 may not consume power, or may reduce power consumption.

The processors 118, 170 may schedule the communication interfaces 115, 165 to switch between the sleep mode and the wake-up mode periodically every frame time (e.g., 11 ms or 16 ms). For example, the communication interfaces 115, 165 may operate in the wake-up mode for 2 ms of the frame time, and the communication interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced or minimized.

In some embodiments, the processors 118, 170 may configure or cause the communication interfaces 115, 165 to resume communication based on stored information indicating communication between the computing device 110 and the HWD 150. In the wake-up mode, the processors 118, 170 may generate and store information (e.g., channel, timing) of the communication between the computing device 110 and the HWD 150. The processors 118, 170 may schedule the communication interfaces 115, 165 to enter a subsequent wake up mode according to timing of the previous communication indicated by the stored information. For example, the communication interfaces 115, 165 may predict/determine when to enter the subsequent wake up mode, according to timing of the previous wake up mode, and can schedule to enter the subsequent wake up mode at the predicted time. After generating and storing the information and scheduling the subsequent wake up mode, the processors 118, 170 may configure or cause the wireless interfaces 115, 165 to enter the sleep mode. When entering the wake-up mode, the processors 118, 170 may cause or configure the communication interfaces 115, 165 to resume communication via the channel or frequency band of the previous communication indicated by the stored information. Accordingly, the communication interfaces 115, in 165 entering the wake-up mode from the sleep mode may resume communication, while bypassing a scan procedure to search for available channels and/or performing handshake or authentication. Bypassing the scan procedure allows extension of a duration of the communication interfaces 115, 165 operating in the sleep mode, such that the computing device 110 and the HWD 150 can reduce power consumption.

In some embodiments, the computing devices 110A, 110B may coordinate operations to reduce collisions or interferences. In one approach, the computing device 110A may transmit a beacon frame periodically to announce/advertise a presence of a wireless link 125A between the computing device 110A and the HWD 150A and can coordinate the communication between the computing device 110A and the HWD 150A. The computing device 110B may monitor for or receive the beacon frame from the computing device 110A, and can schedule communication with the HWD 150B (e.g., using information in the beacon frame, such as an offset value) to avoid collision or interference with communication between the computing device 110A and the HWD 150A. For example, the computing device 110B may schedule the computing device 110B and the HWD 150B to enter a wake-up mode, when the computing device 110A and the HWD 150A operate in the sleep mode. For example, the computing device 110B may schedule the computing device 110B and the HWD 150B to enter a sleep up mode, when the computing device 110A and the HWD 150A operate in the wake-up mode. Accordingly, multiple computing devices 110 and HWDs 150 in proximity (e.g., within 20 ft) may coexist and operate with reduced interference.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space. The content provider 130 may encode the image data describing the image, and can transmit the encoded data to the HWD 150. In some embodiments, the content provider generates and provides the image data to the HWD 150 periodically (e.g., every 11 ms or 16 ms).

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

In some embodiments, a scheduler 118 (e.g., scheduler 118A of the computing device 118A and/or scheduler 118B of the computing device 110B) may request rTWT to transmit latency sensitive traffic using P2P communication. The AP 105 and scheduler 118 of the computing devices 110 may negotiate (e.g., perform a handshake process) and may establish a membership of a restricted TWT schedule. In some embodiments, when the AP 105 and the scheduler 118 are negotiating, the AP 105 may be considered a restricted TWT scheduling AP and the computing devices 110 may be considered a restricted TWT scheduled STA.

In some embodiments, the HWD 150 may request to send P2P traffic to the computing device 110. Accordingly, the HWD 150 may be considered the TWT requesting STA (e.g., the TWT STA that requests the TWT agreement), and the computing device 110 may be considered TWT responding STA (e.g., the TWT STA that respond to the TWT request). The communication link 125 between the computing devices 110 and the HWDs 150 may be a P2P link (e.g., a link used for transmission between two non-AP devices). The communication link 102 between the computing devices 110 and the AP 105 may be any channel or other type of link. In some configurations, the HWD 150 may move/become out of range from the access point 105. In other embodiments, the computing device 110 may request to send P2P traffic to the HWD 150 such that the computing device 110 is considered the TWT requesting STA and the HWD 150 is the TWT responding STA.

The schedulers 118 of the computing devices 110 may schedule communication between the computing device(s) 110 and the HWD(s) 150 with the AP 105 such that the communication between the computing device(s) 110 and HWD(s) 150 is protected. The computing device(s) 110 may initiate such protected P2P communication with the HWD(s) 150 by indicating, to the AP 105, that the computing device(s) 110 wish to schedule P2P communication in rTWT service periods (SPs). The scheduler 118 of the computing device(s) may schedule (or negotiate) the requested rTWT SP(s). The scheduler 118 of the computing device(s) may also indicate if the SP(s) are requested only for P2P communication (as compared to mixed P2P communication and non-P2P communication).

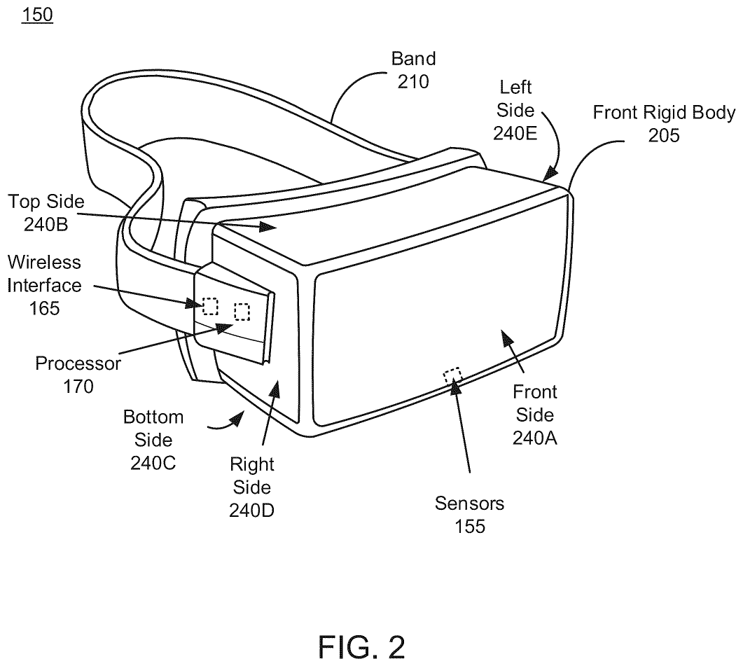

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not be visible to the user. In other embodiments, the HWD 150 has a different configuration than shown in FIG. 2. For example, the processor 170, the eye trackers, and/or the sensors 155 may be in different locations than shown in FIG. 2.

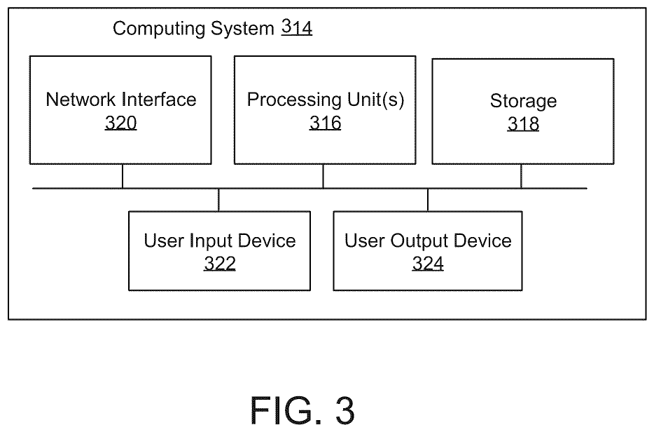

Various operations described herein can be implemented on computer systems. FIG. 3 shows a block diagram of a representative computing system 314 usable to implement the present disclosure. In some embodiments, the computing device 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHZ, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

FIGS. 1-3 illustrate devices that communicate traffic streams, some of which may be latency sensitive (e.g., those carrying periodic AR/VR information/content, such as according to a frame refresh rate). As described herein, the periodic operation of TWT benefits communication of periodic traffic (e.g., latency sensitive traffic) by predictably communicating the periodic traffic. However, the various devices may be located proximal to devices of other networks. This co-location can lead to interference between the various wireless communications of the devices. In some embodiments, devices of the networks can coordinate scheduling, such as to synchronize schedules (e.g., for relatively orthogonal wireless messaging) or to time-slice available time for exclusive provision of one or more networks. For example, a representative device of each network can (e.g., access point (AP) of a Wi-Fi network) can communicate with other proximal devices to maintain a schedule for the various networks. The schedule can include overlapping or non-overlapping time slots for TWT operation of the various networks.

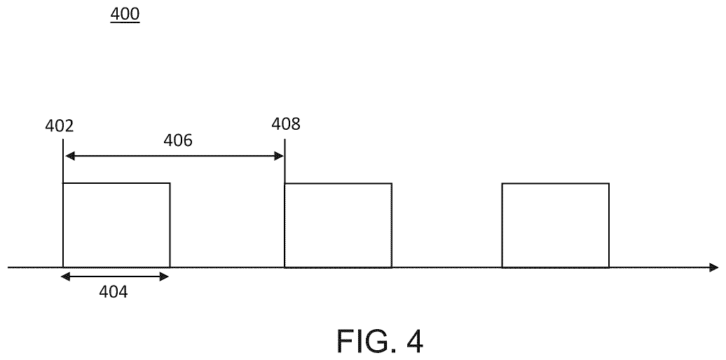

Referring generally to FIG. 4-FIG. 13, the systems and methods described herein may manage target wake time scheduling and scheduling groups between representative devices of proximal networks. Such devices can include stations (STAs), and access points (APs), including a mobile AP (“hotspot”), Wi-Fi direct group owner (GO), or a device configured to alternatively operate as an AP and/or a STA. Various non-AP devices in network communication with an AP device are sometimes referred to as a service set (SS) of the AP. A combination of an AP with various other STA devices (the SS), along with communication protocols and network configurations for communication therebetween may be referred to as a basic service set (BSS). Various BSSs can be co-located, such as when one device is couplable to multiple networks, or when separate network devices are proximal to one-another. For example, an apartment building can include numerous BSSs sharing a same medium, or a wireless gaming device can establish an ad-hoc network related to an existing infrastructure network. The multiple BSSs sharing the same wireless medium may be referred to as overlapping BSS (OBSS).

Simultaneous operation of OBSS networks can induce latency according to, for example, retransmissions related to co-channel or adjacent channel interference between the various BSS. Delayed latency sensitive traffic may degrade a user experience. For example, in an AR/VR context, latency between a movement of a user wearing an HMD or related device and an image corresponding to the user movement and displayed to the user using the HMD device may cause judder, resulting in motion sickness.

A Target Wake Time (TWT) is a mechanism where a set of service periods (SPs) are defined and shared between devices to reduce medium contention and improve the power efficiency of network devices. The TWT can reduce latency by pre-defining medium access times for one or more devices. The TWT can also reduce energy consumption of the devices by limiting the awake time and associated power consumption of the devices. For example, the first device can wake up periodically based on the TWT schedule to send or receive information. During the SP, a device may be in an awake state (e.g., its wireless communication module/interface is in a fully powered-up, ready, or wake state) and is able to transmit and/or receive. Outside of the SP, the device the device may not remain awake (e.g., its wireless communication module/interface is in a powered-down, low power, or sleep state), which may reduce a power use or a thermal load of the first device.

Managing network latency along with sleep states can prove challenging, particularly so in a dense network environment. For example, although signaling within a BSS may be used to coordinate TWT schedules between an AP device and one or more non-AP devices, medium availability may depend on network activity of OBSS. As indicated above, these OBSS can include related devices or devices which are not explicitly functionally related. For example, a first BSS of OBSSs can include devices managed by a same access controller, as in the case of a same device couplable to multiple networks. A second BSS of OBSSs can include wireless routers or laptop computers in adjacent homes.

Although certain frames (e.g., beacon frames) may be available to AP devices of multiple overlapping BSSs, other frames may not be broadcast between the networks. Moreover, frames including scheduling information can include more information than would be needed to coordinate schedules between APs. Additional processing of such frames may increase power use or incur further latency. Further, if shared with nearby BSSs, certain TWT scheduling informational frames may reveal network configurations relevant to network security. Moreover, even if shared, present frames structured for intra-BSS communication may lack certain indications as may be useful for inter-BSS coordination.

The TWT schedule can be agreed/negotiated upon by a device (e.g., APs of a first and second BSS), and/or specified/configured by one device (e.g., the AP the first BSS) and indicated to further devices (e.g., the AP the second BSS). For example, a schedule may be defined for one BSS, and communicated to other BSSs which may align their own TWT schedule (or disregard the communication). The alignment of the TWT schedules can include aligning a start time of TWT intervals (e.g., spatial reuse), or exclusively scheduling TWTs (e.g., exclusive medium access).

In some embodiments, APs of various overlapping BSSs can explicitly coordinate according to one or more coordination levels. For example, the APs can negotiate membership in a group including a group owner. A group can include any number of APs, corresponding to any number of BSSs. An AP can be a member of (e.g., own or subscribe to) multiple groups. An AP can depart a group upon providing a termination of membership. Termination of membership by a group owner can terminate a group. A group owner can provide TWT scheduling information to any subscribers of the group. For example, each of the group owner and the subscribers can consist of AP devices, which can each, in turn, manage TWT scheduled within a respective BSS to accord to the group schedule. Group subscribers are sometimes referred to as group members, without limiting effect.

FIG. 4 is a timing diagram 400 showing a wake-up/sleep schedule of a computing device utilizing TWT, according to an example implementation of the present disclosure. The TWT start time is indicated by the computing device 110 (e.g., a portion of its relevant modules/circuitry) waking up at 402. The computing device 110 may wake up for a duration 404 defined by a SP. After the SP duration 404, the computing device 110 may enter a sleep state until the next TWT start time at 408. The interval of time between TWT start time 402 and TWT start time 408 may be considered the SP interval 406. The communication and/or negotiation of the duration 404 between devices can lower energy use (e.g., wherein a device can enter a sleep state between durations 404), and improve latency/network congestion (e.g., by scheduling restricted time periods for particular latency sensitive data).

A TWT schedule may be communicated and/or negotiated using broadcast TWT (bTWT) and/or individual TWT (iTWT) signaling. In some embodiments, the TWT schedule for an iTWT can specify the SP interval 406 according to an integer number of microseconds. In some embodiments, the TWT schedule for a bTWT can specify the SP interval 406 according to an integer number of time units (TU), each consisting of 1024 microseconds (μs). TWT schedule information may be communicated to particular (individual) devices using a mode such as a Network Allocation Vector (NAV) to protect the medium access of TWT SPs. In contrast, to signal bTWT, in some embodiments, a device (such as AP 105) may schedule TWT SPs with other devices (e.g., computing devices 110 and/or HWDs 150) and may share schedule information in beacon frames and/or probe response frames. Sharing schedule information using bTWT may reduce overhead (e.g., negotiation overhead) as compared to the overhead used when sharing information using iTWT.

In some instances, the TWT schedule for the SPs of a first network may not align with a TWT schedule for another network. For example, in the case of a Wi-Fi network, a first TWT schedule for a first BSS identifier (BSSID) may not align with a second TWT schedule for a second BSSID. The first and second BSSIDs can operate on same or adjacent frequency channels within a given area as may give rise to co-channel or adjacent-channel interference. The alignment of the OBSSs can refer to an alignment of a concurrent time slice (e.g., duration 404) for multiple BSSIDs of the OBSSs, or to an exclusive time slice apportioned to one or more BSSID of the OBSSs.

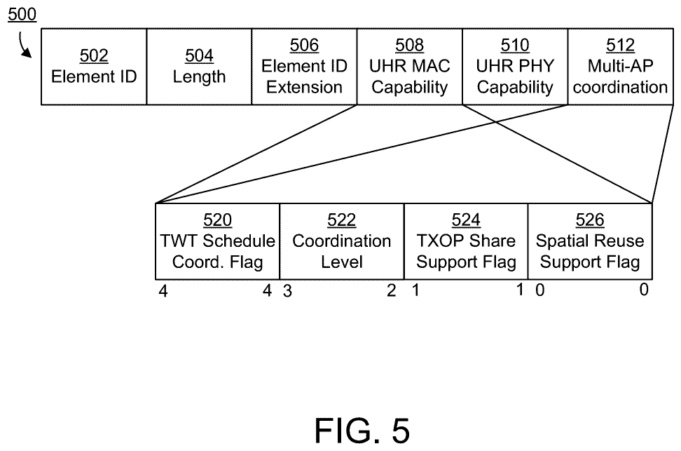

FIG. 5 is a diagram showing an example field to convey target wake time coordination information between access points of overlapping basic services sets, according to an example implementation of the present disclosure. The field may be provided as a portion of any beacon frame or probe response frame sent by a device (e.g., an AP device). For example, the field may be provided as an ultra-high-reliability (UHR) capabilities IE 500. The particular organization of the subfields, as depicted herein, is merely illustrative and is not intended to be limiting. For example, a relative location, number of bits, or other fields relationships can vary from the illustrated embodiment of FIG. 5. Further, references to a field and subfields are not intended to limit a data element. For example, a particular combination of bits may be referred to as a subfield of another field, or as a field. A subset of the combination of bit may also be referred to as a subfield (of the field) or a field, also without limiting effect. Moreover, in some embodiments, any of the depicted subfields of the present disclosure may be omitted or presented according to another format (e.g., a multi-bit field instead of a single bit flag or vice versa).

The depicted subfields may include an element ID 502 to identify the element (e.g., field) as an ultra-high-reliability (UHR) capability IE 500, or to otherwise identify the field according to embodiments wherein the subfields are otherwise organized. A length subfield 504 can provide a length of the further portions of the UHR capability IE 500 (e.g., exclusive and/or inclusive of the element ID 502 and/or length subfield 504). An element ID extension subfield 506 can include an extension to the octet of the element ID 502 to further specify the contents of the UHR capability IE 500. Further fields can include any of a media access control (MAC) capability subfield 508 to advertise MAC layer capabilities (e.g., scheduling, QoS, or power management features), a physical layer (PHY) capability subfield 510 to advertise PHY layer capabilities (e.g., modulation schemas, spatial streams, bonding, or spatial re-use), or a multi-AP coordination subfield 512 to advertise supported inter-AP coordination.

As referred to hereinafter, references to an AP can refer to an AP (e.g., AP, soft AP, peer-peer (P2P) Wi-Fi direct device) for a particular BSS. For example, the AP can be an AP of a mesh network, such that operation of the AP can physically correspond to more than one physical device. That is, the references to the AP may refer to at least one AP of a particular BSS. Further, the groups or coordination described herein can correspond to any number of OBSS. Where a first and second AP are described herein, they can refer to two of any number of APs of a group. For example, coordination between a first and second AP can relate to coordination of membership in a group which includes a third, fourth, or fifth AP (corresponding to a third, fourth, or fifth BSS).

The UHR capability IE 500 can include further subfields, as are depicted as constituent to one or more of the MAC capability subfield 508 and the multi-AP coordination subfield 512, according to the depicted illustrative example. These further subfields include a TWT schedule coordination indicator, depicted as a one-bit TWT schedule coordination flag 520. The TWT schedule coordination indicator can indicate support for TWT schedule coordination. For example, a ‘1’ can correspond to support for at least some TWT schedule coordination operations between APs, and a ‘0’ can indicate a lack of such support. A coordination level subfield 522 is depicted as a two-bit subfield to indicate, with further granularity, supported operations. In some embodiments, the TWT schedule coordination flag 520 and the coordination level subfield 522 are provided as a same subfield (e.g., with a value of “000” corresponding to a flag value of zero and other values configured to indicate supported operations). A lower coordination level can refer to decreased coordination. For example, a scheduling announcement level or scheduling alignment level may be referred to as below a joint scheduling level.

The coordination levels can include an OBSS schedule announcement level, sometimes referred to as level zero coordination corresponding to a scheduling announcement. According to level zero coordination, a first AP of a first BSS may announce TWT schedules to various devices of the first BSS. For example, the first AP can determine, based on beacon and probe response frames received from a second AP of a second BSS, a TWT schedule for the second BSS. Various devices of the first BSS (e.g., the first AP) can, responsive to a receipt of the announcement of the TWT schedule of the second BSS, adjust BSS schedules or information transmitted in a duration 404 of the schedules. However, the first BSS may not guarantee that any particular rescheduling, alignment, or adjustment will occur. Such a level may be useful where one or more STA or other devices of a network is not configured to support the adjustments, or where latency, power use, or other impacts of the OBSS signaling has not interrupted access to a wireless medium by less than a predefined threshold (e.g., received signal strength indicators RSSIs, signal to noise ratios (SnR), or symbol error rate, packet drop rate, etc.).

In some embodiments, TWT groups are not shared between BSS. That is, devices of the second AP may not request membership in a TWT group of the first AP, through such devices can follow any rules or scheduling as if they were a member of the group, based on the announced scheduling (and any other TWT information provided therewith). Thus, STA devices can form “soft groupings” which may generally operate as a member of a group without formal membership. Such operation may provide low-overhead and avoid at least some media contention.

The coordination levels can include an OBSS aligned schedule level, sometimes referred to as level one coordination corresponding to scheduling alignment. According to level one coordination, a first AP of a first BSS may coordinate start times 402 for SPs with a second AP of a second BSS. For example, if both APs intend to setup a schedule with a wake interval of 16 ms, they may coordinate to define same start times for these schedules to avoid overlapping or redundant schedules. If these schedules are R-TWT schedules, STAs may end their TXOPs at SP start boundary for a start time 402. If schedules are aligned, this TXOP stopping/ending may also be aligned so as to aid with efficient usage of the wireless medium. However, each BSS (e.g., an AP thereof) can manage TXOP termination separately, in some embodiments.

The coordination levels can include joint schedules, sometimes referred to as level two coordination corresponding to joint scheduling or multi-BSS schedules. Level two coordination can expand upon the schedule parameters negotiated for level one coordination. For example, the expanded negotiated parameters can include one or more of start time 402, duration 404, or wake interval 406 for a TWT. In some embodiments, the expanded negotiated parameters include advanced scheduling mechanisms. Advanced scheduling mechanisms can include, for example, spatial reuse techniques, trigger schedules (indicated via sharing QoS Characteristics element) or transit opportunity (TXOP) sharing techniques. In some embodiments, BSS groups of STAs can span multiple OBSSs at coordination level two. That is, a group can include one or more STAs from a first BSS and one or more STAs from a second BSS.

Referring generally to joint scheduling, a first AP may learn about TWT Schedule Coordination Support and Capabilities of a second, neighboring AP, by listening to the second APs beacon frames, and parsing a UHR Capabilities element 500 (or any other element that carries capability indication). Where neighboring APs support TWT schedule coordination as advertised in the beacon or probe response frames, one of the neighboring APs can initiate a schedule coordination agreement request by sending an individually addressed frame to the other of the neighboring APs. For example, the requesting AP can detect the coordination supported by the other AP, retrieve an own level of support, and request for coordination at (or below) the highest level supported (e.g., advertised) by each AP. That is, the level of coordination in the TWT schedule coordination agreement generally specifies the highest level of potential coordination between the two APs. However, in some embodiments, APs can coordinate a lower level of coordination (e.g., to maintain alignment to periodic video data or to better coordinate with a different OBSS).

With continued reference to joint scheduling, each schedule may have an owner (e.g., host, manager, or initiator). For example, the owner can amend any TWT parameters (including ownership). A group owner is also the owner of a schedule for the group. That is, an AP of a first BSS can own a schedule for a group including one or more devices of a second BSS. For example, the owner may be identified according to a BSSID and a Schedule ID, as may be carried in a TWT element or other fields provided herein. In some embodiments, the TWT elements or other fields include a list of all BSSs (e.g., according to their respective BSSID) for which the schedule is in effect. A joint schedule may include a schedule ID (e.g., broadcast TWT ID) and originator ID (e.g., BSSID of the AP creating or initiating the schedule).

An AP can establish a joint schedule simultaneously across multiple BSS, or may establish the schedule at a first BSS, and thereafter propagate the schedule to further BSSs according to various embodiments and implementations of the present disclosure. For example, an AP can provide a TWT setup frame or another management/action frame to establish or propagate the joint schedule. In some embodiments, an initiating AP may indicate that a schedule is provided as a joint schedule. Such an indication can be provided via, the assignment of multiple BSS/schedule IDs to the schedule, or otherwise, such as via a flag.

A coordination level negotiated between two or more AP may not necessarily apply to all schedules of those APs. For example, in some embodiments, separate TWT schedules may be provided to align with separate video data, such that the APs may elect to conduct such schedules asymmetrically (to decouple the effective transmission of video frame rate data between the BSSs). Such asymmetric operation can be according to level zero coordination, or can lack even level zero coordination, in some embodiments. However, other schedules of the respective APs can operate at higher levels of coordination. The respective APs can determine a coordination level responsive to a data type associated with a TWT, or a type of TWT (e.g., iTWT, bTWT, or rTWT). Moreover, in some embodiments, an AP sharing a TWT schedule for another BSS can announce schedules of differing durations 404 that the original schedule, but with same start times 402 and wake intervals 406. Such operation may be useful to, for example, opportunistically harvest uncontended medium access times for TWTs which are frequently terminated early or otherwise unused, or to reduce active time in a low-bandwidth BSS while maintaining schedule coordination.

In some embodiments, an AP may implement delegation of certain operations. For example, an AP may add or remove its own BSS or other identifier from a schedule description. In general, however, an initiator AP will accept new member APs (or new BSS) into a TWT schedule coordination group (“group”). To accept the new AP, the initiator AP may send a frame with schedule inflation and a receiving AP provides an accept command to the initiating AP. Upon (and responsive to) the acceptance, the respective APs may be both a member of the joint schedule, and both APs announce the schedule within their respective BSSs. Further, incident to another AP joining the group, the initiator AP can include a BSSID or other identifier of the new AP to any future advertisements of the schedule. Conversely, upon removal from the group, an owning AP can remove the BSSID or other identifier from future advertisements.

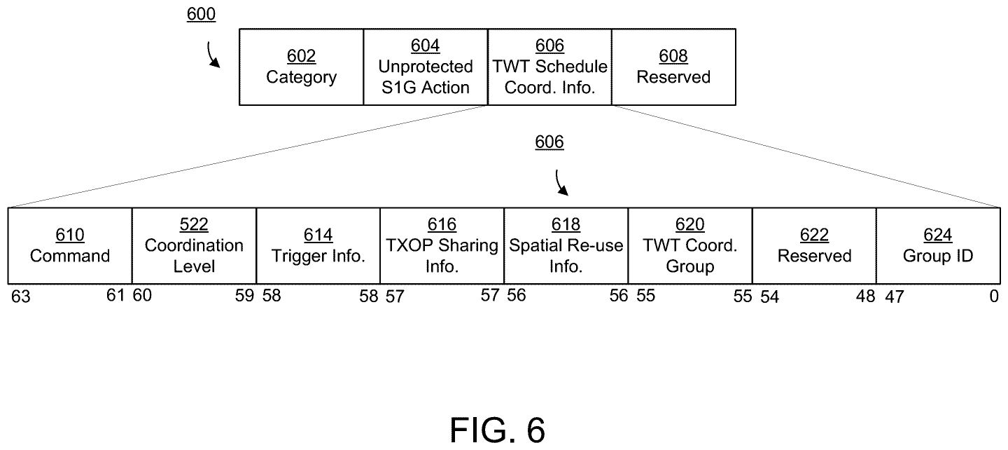

Referring generally to TWT schedule coordination groups, the groups can include any number of APs, and the APs can be a member of any number of groups. Moreover, an AP can terminate membership in a group at any time by announcing or otherwise indicating an intention to leave the group. In some embodiments, the departing AP can announce an intention to leave a predefined time prior to leaving. Where a group owner departs from a group, the group may be terminated. However, in some embodiments, a group owner may announce an intention to leave a predefined amount of time in advance of a departure (e.g., corresponding to a predefined number of target beacon transmissions). In some embodiments, another AP can receive ownership of a group subsequent to the announcement of the previous owner's departure but prior to the termination of the group. The groups of APs, like the joint schedules for the BSS, can be negotiated similarly to the joint schedules, as indicated according to a TWT coordination group subfield 620 discussed hereinafter with regard to FIG. 6. A group initiator, or other owner may also manage a corresponding joint schedule of related BSS of the group of APs. Any member of the group (e.g., any AP) can initiate a request with a group owner to start a joint schedule. Thus, a group of APs may be established prior to the formation of a joint schedule, wherein the joint schedule is formed based on a request from an AP of the established group.

In some embodiments, one or more APs operating according to a scheduling coordination agreement can terminate such agreement by sending an action or management frame indication such termination. However, subsequent to such termination, either AP may continue to optionally announce the other APs schedule. In some embodiments, the continued announcements may extend for a time negotiated according to the terminated agreement. However, such operation need not be pre-coordinated. Indeed, in some embodiments, an AP may announce another APs schedules absent any coordination agreement whatsoever. For example, the sharing AP can detect the information according to a receipt of an action or management frame from another AP. Such communication can be directly or indirectly. For example, in some embodiments, such communication can be received from a side-channel or a management device separate from the either AP. To trigger schedules, the AP can generate trigger frames to solicit data without waiting for a previously scheduled time.

Referring particularly to the TXOP sharing techniques, an AP or other device of a BS can indicate support or non-support for such functionality. An example indicator is provided according to the TXOP share support flag 524. The TXOP share support flag 524 can indicate an alignment of TXOP between different BSS. An AP can schedule TXOPs to coincide with TWT durations 404, so that upon waking, a STA or other device can transmit data without medium contention within a BSS. Further, the TXOP sharing techniques can aid multiple STA of one or more BSS (e.g., of a group) to share a same scheduled TXOP. For a restricted TWT (rTWT), all AP of a same schedule can end a TXOP at a SP start time 402. Moreover, the rTWT can indicate traffic identifiers (TIDs) carrying latency sensitive traffic (e.g., indicating video traffic according to the previous example of latency sensitive video transmission). The TIDs may be defined according to negotiation between one or more STA and an AP, rather than being a property of the schedule itself, (e.g., the group owner/manager may not manage TID).

With continued reference to TXOPs generally, in some embodiments, all APs of a schedule may end their TXOP at an SP start time 402 to avoid contention between OBSS. An AP (e.g., originating AP) may be excepted from terminating a TXOP to deliver traffic of an rTWT schedule. If a first rTWT of a first BSS is ongoing simultaneously to a second rTWT of a second BSS (as in the case of overlapping SP durations 404), devices of the respective BSSs can terminate a TXOP. In some embodiments, the devices can transmit any non-rTWT traffic (e.g., non rTWT TID traffic), but may proceed with scheduled rTWT transmissions. In some embodiments, the devices can end a TXOP regardless of whether rTWT TID traffic is being delivered upon the start of another rTWT SP.

Referring particularly to the spatial reuse techniques, an AP or other device of a BS can indicate support or non-support for such functionality. An example indicator is provided according to the spatial reuse support flag 526.

In some embodiments, an AP or other device of a BSS can determine an OBSS schedule announcement level based on the AP alone. In some embodiments, an AP or other device of a BSS can determine an OBSS schedule announcement level based on various connected devices within a same BSS. For example, where some STA devices do not support certain TWT operations, the AP can advertise non-support for such operation, or non-support for such operations at least for a group including the STA devices. In other embodiments, or for other features, an AP device may implement certain aspects of the coordination transparent to the STA devices, such that the AP device can advertise support for an operation which is not specifically supported by STA devices of a same BSS.

FIG. 6 is another diagram showing an example field to convey target wake time coordination information between access points of overlapping basic services sets, according to an example implementation of the present disclosure. The frame may be provided as an unprotected sub-one gigahertz (SIG) frame 600, in some embodiments. Such an implementation can aid the signal to travel between APs where STA devices of a BSS overlap, but AP inter-communication may be marginal or non-existent. In some embodiments, similar effects can be realized via side-band communication, adjusted power levels or signal rate, etc. As for the UHR capability IE 500 of FIG. 5, the particular organization of the fields provided herein are not intended to be limiting. Indeed, in various implementations contemplated according to the present disclosure, some fields may be omitted, added, modified, or substituted. For example, at least some subfields may be provided within existing or repurposed fields (e.g., reserved bits) of other frames used to manage TWT or other Wi-Fi operation.

A first subfield 602 of the SIG frame 600 provides a category the action frame which can indicate a category, such as a specific category for multi-AP coordination or UHR capabilities. A second subfield 604 of the SIG frame 600 indicates a frame type, which, according to the present illustrate example, is provided as an SIG frame 600 but which, as indicated above, can be provided according to various fields or subfields according to various embodiments. A third subfield 606 of the SIG frame 600 indicates a TWT scheduling coordination information. Some examples of data elements of the TWT scheduling coordination information are provided below, in further detail. Before turning to the TWT scheduling coordination information, further bits are depicted according to a reserved subfield 608 as tasked for other purposes, such as future development or proprietary implementations.

Referring again to the third subfield 606, further constituent subfields include a command subfield 610 to indicate a command or action being performed by the frame. The command subfield 610 can include an indication of any of various commands. For example, according to the depicted embodiment, the third subfield 606 includes three command bits defining eight command options. A first of the command options can correspond to a request to establish a TWT scheduling agreement. A second of the command options can correspond to an acceptance of a requested TWT scheduling agreement. A third of the command options can correspond to a proposal of alternative coordination parameters as has been requested (sometimes referred to as a counter-request). A fourth of the command options can correspond to a rejection of a proposed agreement or a termination of an existing TWT scheduling agreement. A fifth of the command options can correspond to a request to share TWT coordination group information, as are hosted by a recipient thereof. A sixth of the command options can correspond to a request to join a TWT coordination group.

A coordination level subfield 522 may be provided as duplicate to, or instead of the coordination level subfield 522 of FIG. 5. For example, the frames depicted in FIGS. 5 and 6 can depict frames of alternative embodiments of the present disclosure, or frames used for different purposes within a same embodiment. In some embodiments, the coordination level subfield 522 is omitted from one or more of the fields depicted in FIGS. 5 and 6. Likewise, each of the trigger information subfield 614, TXOP sharing information subfield 616, and spatial reuse subfields 618 can include different, more granular, same information as the trigger information, TXOP share support flag 524, or spatial reuse support flag 526 respectively (or at least one subfield may be omitted). Further subfields may be provided according to one or more set flags. More particularly, a further trigger information field may be instantiated to provide trigger information when a bit of a trigger information subfield 614 is set; a further TXOP share information field may be instantiated to provide TXOP share information when a TXOP share support flag 524 is set; a further spatial reuse information field may be instantiated to provide spatial reuse information when a bit of the spatial reuse support flag 526 is set.

A TWT coordination group subfield 620 (e.g., flag) can indicate that the SIG frame 600 is related to management of one or more groups. Where the flag is set, at least one group may be indicated in a group identifier subfield 624. Where the flag is cleared, the group identifier subfield 624 may be omitted. Further bits are provided according to a further reserved field 622.

Referring back to the command options of the third subfield 606, a first AP may send a TWT Schedule Coordination Agreement frame with a “request” command to establish an agreement with parameters specified by various populated other subfields of a same or related frame. Upon receipt of the request command, or an alternate command received responsive to a previous transmitted request command, a receiving AP can respond with an accept command to establish the agreement. Upon a receipt of the acceptance frame, and first AP can determine that the agreement is in place. The first AP can further acknowledge (ACK) the acceptance frame. The second AP can determine that the agreement is in place upon a receipt of the ACK (or upon sending the acceptance). Conversely, a response of a rejection command can indicate that no TWT coordination agreement is formed. Where a rejection command is received subsequent to establishing the coordination agreement, the rejection can terminate the agreement (e.g., immediately or upon receipt/provision of an ACK). Where a TWT coordination group flag 620 is cleared, such operations may be performed globally for all groups of respective BSSs. Where a TWT coordination group flag 620 is set, such operations may correspond to one or more groups indicated in a group ID subfield 624.

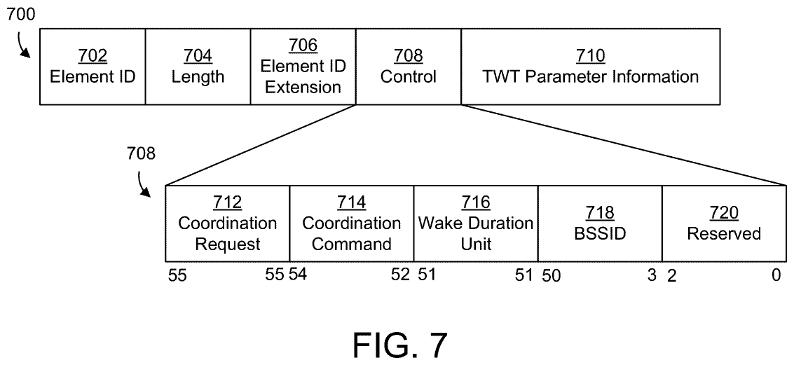

FIG. 7 is a diagram showing an example field 700 to convey target wake time information between network connected devices, according to an example implementation of the present disclosure. The field 700 can include any of various subfields including an Element ID subfield 702, a length subfield 704, an element ID extension subfield 706, a control subfield 708, and a TWT parameter information subfield 710. In some embodiments, the field 700 includes any number of instances of the TWT parameter information subfield 710, each instance corresponding to a schedule for a particular repeating instance of a TWT.

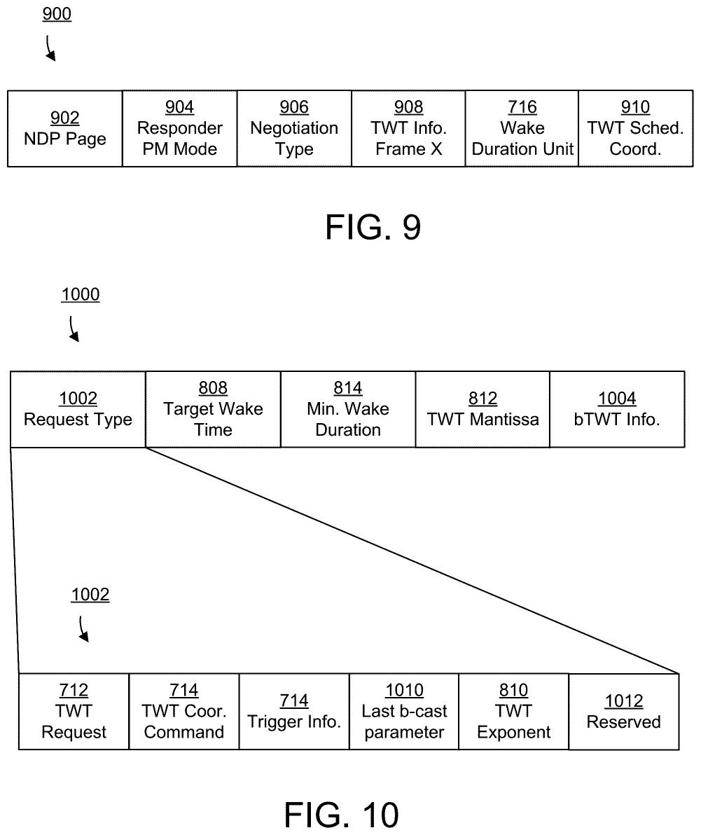

More particularly, the field 700 of the present figure is provided as a newly defined information element (IE) for TWT schedule sharing and coordination. The particular organization of the subfields, as depicted herein, is merely illustrative and is not intended to be limiting. Further fields provided henceforth may be configured to communicate similar information via repurposing of other TWT-related IE or other fields, as may be useful to interoperate with legacy devices, in some embodiments. For example, a relative location, number of bits, or other fields relationships can vary from the illustrated embodiment of FIG. 7, some examples of which are indicated by illustrative examples of FIGS. 9 and 10, below.

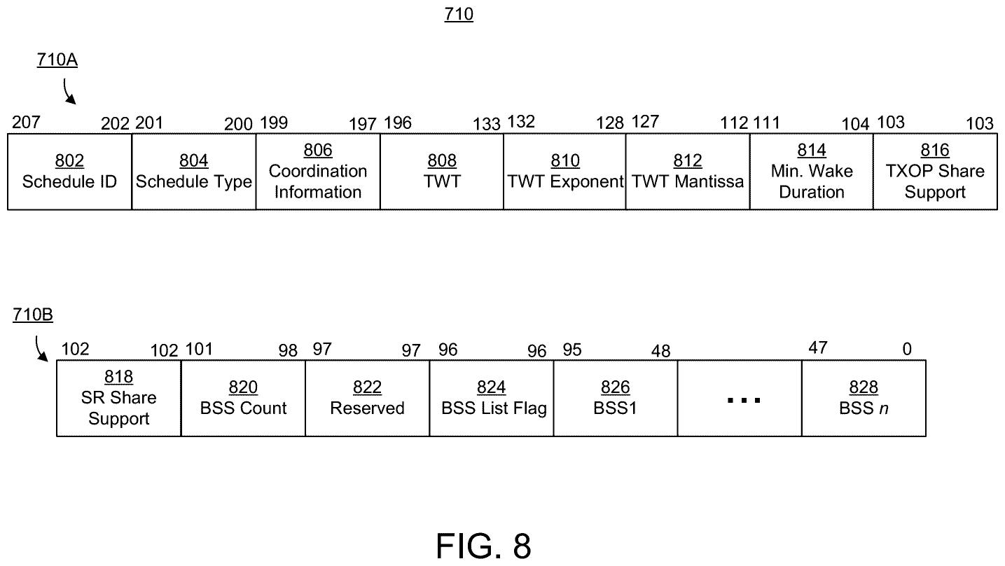

The depicted subfields of the field 700 of FIG. 7 include an element ID 702, length 704, and extension subfield 706 which can include similar information as the element ID 502, length 504, and extension subfield 506 of the UHR capability IE 500 of FIG. 5. That is, the element ID 702 can indicate a separate identifier specific to the provided TWT schedule IE field 700, the length subfield 704 can identify a length of the TWT schedule IE field 700, and the Element ID Extension subfield 706 can include an extension to the octet of the element ID 702 to further specify the contents of the TWT schedule IE field 700. A control subfield 708 can include control data/information/fields/bits for the TWT schedule. An illustrative example of some control bits is provided below. Further, one or more TWT parameter information subfields 710 can provide TWT parameters. An instance of a TWT parameter information subfield 710 can be provided on a per-schedule basis. For example, a TWT schedule IE field 700 indicating three schedules can include three instances of the TWT parameter information subfield 710. An illustrative example of one TWT parameter information subfields 710 is provided henceforth, at FIG. 8.

Referring back to the control subfield 708, the control subfield 708 can include a coordination request subfield 712 which may indicate whether a transmitted message is a coordination negotiation (either a request or response). For example, according to the depicted embodiment, the coordination request subfield 712 is provided as a bit flag to indicate whether the TWT schedule IE field 700 is negotiating. An AP can transmit the TWT schedule IE field 700 or various subfields thereof with a cleared coordination request bitflag for informational purposes (e.g., to aid level zero coordination). An AP can transmit the TWT schedule with a set coordination request bitflag to solicit a response or reply to a request soliciting the response. The control subfield 708 can include a TWT coordination command subfield 714. The coordination command subfield 714 can indicate similar command information to the command subfield 610 of FIG. 6. More particularly, the coordination command subfield 714 can indicate a presence of a coordination request according to a first state, indicate an acceptance of a previously communicated request according to a second state, indicate a presence of an alternate (e.g., counter-request) according to a third state, and indicate a rejection of a coordination request according to a fourth state. As indicated, the coordination command subfield 714 can include more than two bits (e.g., three bits, as is depicted) such that further states may be reserved for future or proprietary use, or may be allocated to further states, or further granularity.

A wake duration subfield 716 can indicate a time unit such as a 1024 microsecond time unit (TU) or another time. A BSSID subfield 718 can indicate a BSSID of an originator AP or other device, or can otherwise indicate an originator or owner associated with the TWT schedule IE field 700. The depicted TWT schedule IE field 700 further includes a reserved bit subfield 720, as described above with regard to further reserved bits of various fields of the present disclosure.

Referring now to FIG. 8, a TWT parameter information subfield 710 is provided in further detail. As described with regard to FIG. 7, although the present fields are provided as a part of a particular TWT parameter information subfield 710 (of a particular TWT schedule IE field 700), the fields may be provided according to other IE, subfields, or so forth. Although some examples are provided henceforth, the various descriptions of the subfields are not repeated in full for subsequent framing. However, any of the description of the data elements described with regard to FIGS. 6 and 7 may also be applicable to other framings of the information of the subfields provided herein, in some embodiments. The depiction of the first portion 710A of the TWT parameter information subfield 710 and the second portion 710B of the TWT parameter information subfield 710 is merely for clarity of the figure.

A schedule ID subfield 802 indicates an identifier for a schedule. Although depicted as a six-bit field, the schedule ID subfield 802 can be provided according to any number of bits. A schedule type subfield 804 can indicate a type of schedule, such as an iTWT schedule, an rTWT schedule, a (non-rTWT) bTWT schedule, or so forth. In some embodiments, the schedule type subfield 804 may be omitted and schedules may be presumed as rTWT schedules. A coordination information subfield 806 can indicate coordination related information, such as level zero, level one, and zero two coordination as described above with regard to the coordination level subfield 522.

A TWT subfield 808, TWT exponent subfield 810, and TWT Mantissa subfields 812 can duplicate (or replace) existing subfields to define a start time 402, duration 404, and interval 406, and of TWT SPs. Further, a minimum wake duration subfield 814 can provide a nominal minimum wake duration. This nominal value may be truncated in some circumstances and in other circumstances can indicate minimum nominal wake time according to other techniques. A TXOP share support indicator 816 (e.g., TXOP share support flag 524) can indicate a presence of TXOP share support, or can indicate a presence (or absence) of a further field to provide additional TXOP sharing information. Likewise, a spatial reuse indicator 818 (e.g., spatial reuse support flag 526) can indicate a presence of spatial reuse support, or a presence of a further information field for spatial reuse. A further reserved bit subfield 822 is provided in line with other such fields provided herein.

A BSS count subfield 820 can indicate a quantity of BSS for which a schedule is in effect. A BSS list indicator (depicted as a BSS list flag 824) indicates a presence of one or more BSS subfields. That is, the BSS list indicator can logically OR the BSS count subfield 820. A first BSS 826 can indicate a BSSID of a first BSS of the BSS count subfield 820. An nth BSS 828 is depicted as a second BSSID according to the provided bit numbering. However, in various embodiments, the TWT parameter information subfield 710 can include any number of BSSID, corresponding to the BSS count subfield 820, although in some embodiments, a BSS of an owner/initiator may be omitted to avoid duplication. That is, a BSSID 718 indicated in the control field 708 of FIG. 7 may be omitted from the TWT parameter information subfield 710. In some embodiments, the BSSID may be duplicated from the control field 708 of FIG. 7.

Where no BSS is present (e.g., where the BSS list flag 824 is cleared or the BSS count subfield 820 is non-zero), each of the first BSS 826 and any other BSS may be omitted. For example, where BSS count is set to 1, the list flag 824 may be set to zero (and no BSSID 826, 828 fields may be included). The depicted fields should not be construed as limiting. In some embodiments, the TWT parameter information subfield 710 can include additional, different, or less subfields. In some embodiments, the TWT parameter information subfield 710 can include a coordination request subfield 712 or a coordination command subfield 714. For example, such fields may be provided as duplicate to or instead of corresponding subfields of the control subfield 708 of FIG. 7.

Referring generally to FIGS. 9-10, some example fields are provided. The provided fields can include one or more subfields previously discussed (e.g., various subfields of the TWT schedule IE field 700). For example, FIG. 9 depicts a control field 900 format including many subfields shared with prior Wi-Fi fields. For example, any of a null data packet (NDP) paging indicator/unavailability mode flag 902, responder PM mode flag 904, negotiation type subfield 906, TWT information frame disable flag 908, or wake duration unit flag 716 are depicted. However, further bits which may be reserved in prior Wi-Fi applications are depicted as a two-bit TWT schedule coordination field 910. In some embodiments, the TWT schedule coordination field 910 can indicate a coordination request (e.g., the coordination request subfield 712). In some embodiments, the TWT schedule coordination field 910 can include coordination information (e.g., all or a subset of the information of the coordination command subfield 714, or coordination information subfield 806). In some embodiments, the TWT schedule coordination field 910 can be defined by other subfields of the field 900 depicted in FIG. 9. For example, the TWT schedule coordination field 910 can be selected according to a non-zero value of the negotiation type subfield 906, wherein the same bits can depict information of another field corresponding to a zero value of the negotiation type subfield 906.

Referring now to FIG. 10, a field 1000 related to a broadcast TWT parameters set field 1000 is provided. Some subfields, such as a target wake time subfield 808 may differ in content or length from TWT parameters set fields 1000 of other Wi-Fi generations. For example, the TWT subfield 808 can be provided as two or eight octets, in some embodiments. Other fields, such as a minimum wake duration subfield 814 and TWT mantissa subfield 812 may be provided as otherwise described herein or according to operation of other Wi-Fi fields. Further fields, such as broadcast TWT information fields 1004 can be provided according to any other Wi-Fi fields. As shown, a request type subfield 1002 (e.g., a two-octet field, as depicted), can include further subfields related to TWT groups. For example, the request type subfield 1002 can include a coordination request subfield 712, TWT coordination command subfield 714, trigger information subfield 614, or TWT exponent subfield 810 to depict information as previously described herein. For example, the TWT coordination command subfield 714 can be provided as a three-bit subfield. In some embodiments, further fields can be included. For example, a reserved subfield 1012 can be purposed to form a (e.g., two-bit) schedule type subfield 804 or a (e.g., three-bit) coordination information subfield 806. In some embodiments, further non-reserved subfields (not depicted herein, such as a flow type field or bTWT recommendation field) may further be purposed for such fields. The request type subfield 1002 can further include other subfields such as a last broadcast parameter subfield 1010 to indicate a last broadcast.

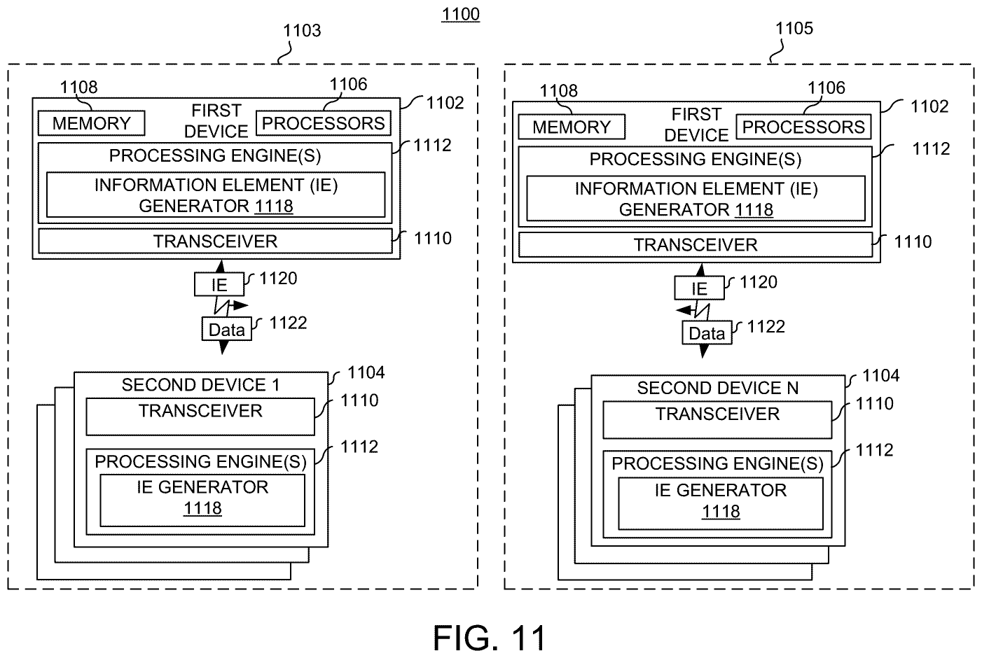

Referring now to FIG. 11, depicted is a block diagram of a computing environment 1100, according to an example implementation of the present disclosure. The computing environment 1100 includes systems for target wake time schedule management. The systems may include a first device 1102 and any number second devices 1104 (referred to generally as a second device 1104) of a first BSS 1103. The systems may include a first device 1102 and any number second devices 1104 (referred to generally as a second device 1104) of a second BSS 1105. In some embodiments, any number of further BSS may be included, which may include further first devices 1102 and second devices 1104, either of which can be included in a TWT group, along with the depicted examples of the first devices 1102 and second devices 1104.

Either of the first device 1102 or any of the second devices can include an AP 105 or a non-AP STA. The first device 1102 and at least a subset of the second devices 1104 may be associated with a same TWT distribution schedule (e.g., for an rTWT). The first device 1102, like the second device 1104, may include one or more processors 1106 and memory 1108, which may be similar, respectively, to the processor(s) 118/170 or processing units 316 and storage 318 described above with reference to FIG. 1-FIG. 3. The first device 1102 and second device 1104 may include respective wireless local area network (WLAN) transceivers 1110 and processing engine(s) 1112. The wireless local area network (WLAN) transceivers 1110 may be similar to the communication interface(s) 115, 165 and the processing engine(s) 1112 may be similar to the processing unit(s) 316, described above with reference to FIG. 1-FIG. 3.

As described in greater detail below, the first device 1102 may include IE generators 1118 configured to generate/establish information elements (IE) 1120 for transmission (in a message) to the second device(s) 1104. The IE 1120 may convey TWT related information between the first device 1102 and second device(s) 1104, such as to establish a TWT, confirm the establishment of the TWT, or adjust the established TWT SP. Moreover, the various first devices 1102 can transmit, send, communicate, or otherwise provide IE 1120 to other of the first devices 1102 to manage groupings or other schedule coordination operations between the first BSS 1103 and second BSS 1105. For example, the IE 1120 can include the UHR capability IE field 500, TWT schedule IE field 900, or other fields discussed herein. The first devices 1102 may be configured to transmit, send, communicate, or otherwise provide the IE 1120 to the second device 1104. The second device 1104 may be configured to transmit, send, communicate, or otherwise provide further IE(s) 1120 to the first devices 1102. The first device 1102 (and/or second devices 1104) can be a TWT scheduled device and/or TWT scheduling device.

The first devices 1102 may be configured to generate/establish payload data 1122 for transmission (in a message) to the second device(s) 1104 or other of the first devices 1102. The payload data 1122 may convey latency sensitive information, such as frame data for provision to a HWD 150 of a VR/AR system, data related to establishment of TWT groups, or data related to management of established groups. The first device 1102 may be configured to transmit, send, communicate, or otherwise provide the IE 1120 to the second device 1104 or other of the first devices 1102. In some embodiments, the second device 1104 may be configured to generate/establish payload data 1122 for transmission to the first device 1102, or to transmit, send, communicate, or otherwise provide further payload data 1122 to the first devices 1102. A timing of such communications may be coordinated between or within BSS according to the IE 1120 exchanged between the first devices 1102. Such communications between the first devices 1102 may be according to addressed communications, or other communications such as beacon frames or probe responses. In some embodiments, one or more of the second devices 1104 can perform any of the operations disclosed as performed by the first device 1102, and the first device 1102 can perform any of the operations disclosed as performed by any of the second devices 1104.

The first devices 1102 and second devices 1104 may support TWT functionalities/tasks/functions for communication during a session between the devices 1102, 1104. The sessions can include scheduled communications within the first BSS 1103. However, these intra-BSS communications can access a same medium as another communication within the second BSS 1105. Accordingly, the first devices 1102 can exchange at least one IE 1120 therebetween to establish a group or otherwise communication coordination information. Responsive to the receipt of inter-first device communication, the first devices 1102 can generate a second IE 1120 to communicate schedule information to second devices of a same BSS. Responsive to the receipt of the second IE 1120 the one or more second devices 1104 of the BSS can establish TWT schedules aligned with further BSS. In some embodiments, the one or more second devices 1104 of the BSS can include every second device 1104 of the BSS. In some embodiments, the one or more second devices 1104 of the BSS can include only second devices 1104 associated with a particular TWT group/schedule.

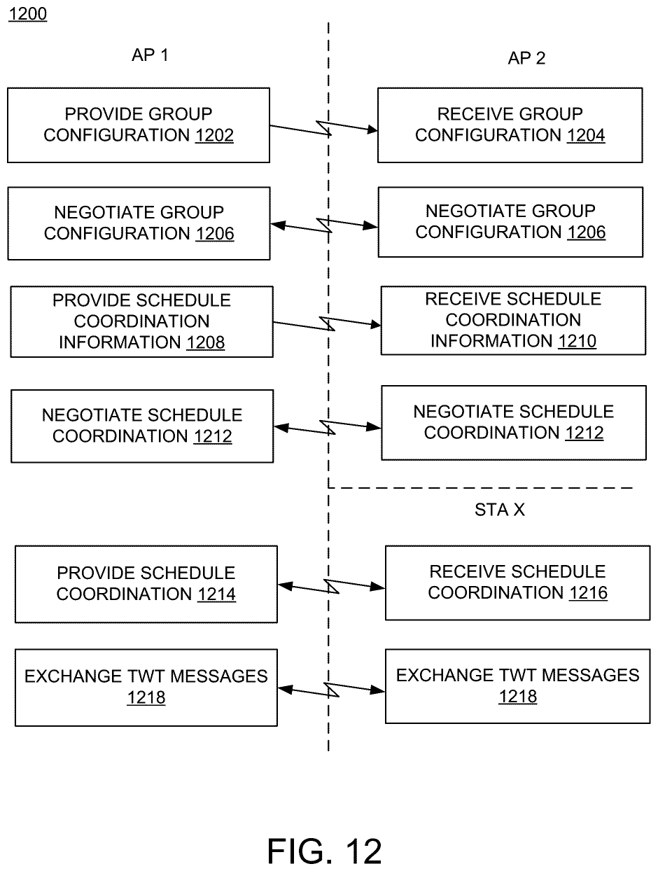

Referring now to FIG. 12, depicted is an interaction diagram or flowchart showing an example method 1200 for forming and managing TWT groups, according to an example implementation of the present disclosure. The method 1200 may be performed by various devices, components, or elements described above with reference to FIG. 1-FIG. 11. In some embodiments, some steps, operations, or processes of the method 1200 may be performed by one device (such as a first device 1102 of a first BSS 1103), and other steps or processes of the method 1200 may be performed by another device (such as a first device 1102 of a second BSS 1105). Either of the first devices 1102 can include an AP 105 of a respective BSS. Merely for brevity of the description of the present method 1200, the example first devices 1102 will be referred to and depicted as AP1 and AP2; such a description should not be construed as limiting. In some embodiments, more than one first device 1102 (e.g., AP3, AP4, etc.) may be present. For example, the operations of the depicted method can be performed by or with additional devices to form groups having any number of AP devices of any number of BSSs. Communications provided herein can be provided according to any of the subfields of FIGS. 5-12, as provided herein or modifications thereof, min various embodiments.

At operation 1202, AP1 can provide an indication of a group configuration to AP2. In some embodiments, AP1 can provide the indication of the group configuration as addressed to AP2, or transmit the indication as a broadcast message (e.g., a beacon frame). In some embodiments, the group corresponds to a schedule. For example, in some embodiments, the indication of the group configuration can include information related to a TWT schedule. That is, operations 1202 and 1208 can be performed concurrently, such as according to a communication of one or more IE 1120.

At operation 1204, AP2 receives the indication of the group configuration. In some embodiments, AP2 can acknowledge or reply to the indication. For example, where the indication is addressed to AP2, AP2 can provide an ACK frame. Where the indication is provided as a command request, the second AP can accept the request according to a transmission of an acceptance, at operation 1206. In some embodiments, the negotiation of operation 1206 can include providing a counter-request, which may be accepted or rejected by AP1. In some embodiments, the negotiation can include transmitting a rejection to AP1 (by AP2) or to AP2 (by AP1). The rejection may terminate the presented method 1200. Any of the various negotiations or indications of operations 1202-1206 can include conveyance of information of the command subfield 610, and other information exchanged incident to the indication of the group configuration at operation 1202 or the negotiation at operation 1206 (e.g., according to a UHR capabilities IE 500).

At operation 1208, AP1 provides schedule coordination information to AP2. The schedule coordination information can include at least an indication of a highest supported coordination level. In some embodiments, the schedule coordination information includes specific scheduling details of a TWT schedule. As indicated above, in some embodiments, operation 1208 may be performed concurrently with or separately from operation 1202. However, even where operations 1202 and 1208 are performed concurrently, further instances of operation 1208 may be provided subsequent to establishment of a first group/a first schedule. Indeed, any of the operations provided herein may be repeated or performed in various sequences. In some instances, operation 1206 may be performed subsequent to operation 1208. For example, a subscriber (or owner) of a group can indicate immediate or pending departure from the group at any time.

In some embodiments, particular scheduling details are provided subsequent to a receipt of the schedule coordination information at operation 1210. For example, at operation 1212, scheduling negotiation can include providing an acceptance, by AP2 to AP1, of a schedule coordination level or particular schedule details. In some embodiments, the acceptance may be provided from AP2 to AP1 (e.g., an acceptance of an initial schedule or schedule information, or a counter-counter request). In some embodiments, the acceptance may be provided from AP1 to AP2 (e.g., a counter-request).

At operation 1214, AP1 provides the negotiated schedule to one or more devices of a same BSS (e.g., one or more STAs). In some embodiments, in addition to or instead of AP1, AP2 can similarly provide the schedule to further devices of a corresponding BSS. Responsive to receipt of the schedule information of operation 1216, the STA devices can, at operation 1218, communicate TWT messages as aligned to the schedule. For example, the alignment may include an alignment of at least a start time of the TWT duration, in some embodiments. The communication can refer to messages exchanged with (e.g., transmitted to or received from) an AP of a same BSS. For example, a STA of a first BSS can exchange messages with AP1 and a STA of a second BSS can exchange messages with AP2.

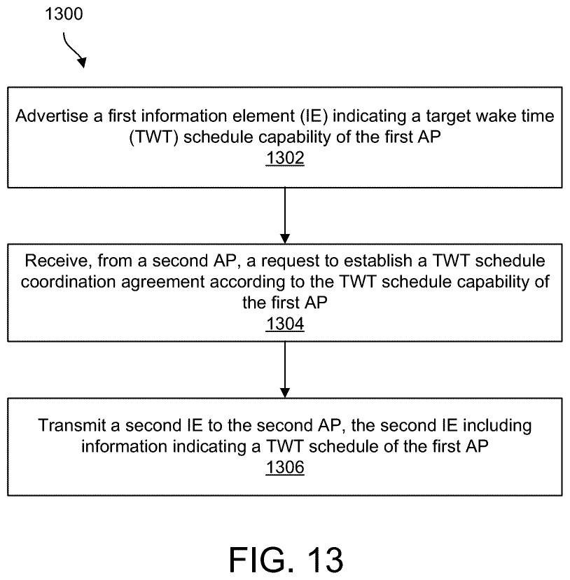

Referring now to FIG. 13, depicted is a flowchart showing an example method 1300 for establishment of at least one TWT schedule coordination group (“group,” hereinafter), according to an example implementation of the present disclosure. The method 1300 may be performed by various devices, components, or elements described above with reference to FIG. 1-FIG. 12. For example, all or some steps, operations, or processes of the method 1300 may be performed by a first device 1102. In some embodiments, steps, operations, or processes of the method 1300 may be performed by another Wi-Fi direct client or other non-AP device, or in conjunction with an AP device. In some embodiments, the first device 1102 includes one of an AP 105 or a (non-AP) STA. Like the method 1200 of FIG. 12, the present method is described as performed by a first AP, AP1 according to communication with a second AP, AP2. Such illustrative language should not be construed as limiting.

At operation 1302, a first AP advertises a first information element (IE) indicating a target wake time (TWT) schedule capability of the first AP. In some embodiments, the first AP can provide the advertisement to a second AP as a broadcast frame (e.g., beacon frame or probe response frame). In some embodiments, the first AP can address the frame to the second AP. For example, in some embodiments, the first AP and the second AP are a group of APs. One of the first AP or the second AP can be a group owner AP. The other of the first AP or the second AP, along with any other APs of the group can include group member APs.

At operation 1304, the AP1 receives, from AP2, a request to establish a TWT schedule coordination agreement according to the TWT schedule capability of AP1. The first IE indicates a level of coordination selected from various levels of coordination, in some embodiments. For example, the request received from the AP2 is provided according to the level of coordination indicated in the first IE. That is, the coordination request may be equal to or less than an advertised coordination level. In some embodiments, the coordination levels correspond to previously described coordination levels 0-2. That is, the coordination levels can include a first level of coordination corresponding to a scheduling announcement, a second level of coordination corresponding to scheduling alignment, and a third level of coordination corresponding to joint scheduling.

At operation 1306, the AP1 transmits a second IE to AP2, the second IE including information indicating a TWT schedule of AP1. The various information of the second IE can include information to establish a TWT schedule/group, or other schedule coordination, such as amending an existing schedule or group. For example, the second IE can indicate, according to a command field similar to the command subfield 610 of FIG. 6, coordination request subfield 712, coordination command subfield 714 of FIG. 7, or BSS list flag 824 of FIG. 8, for details of the establishment or amendment to a schedule/group. In some embodiments, various fields described as fields of the second IE can be provide as a TWT schedule coordination frame including a category field, an action field, and the second IE (e.g., can be provided as, or similar to the SIG frame 600 of FIG. 1). In some embodiments, the fields can be otherwise provided, by one or more other packets, frames, or other conveyances of data.

In some embodiments, the second IE includes a field for a schedule type and a field for coordination information corresponding to the TWT schedule capability. For example, the schedule type field may be provided as or similar to the schedule type subfield 804 of FIG. 8 and the coordination information field can be provided as or similar to the coordination information subfield 806 of FIG. 8.

In some embodiments, the second IE includes a field indicating a count of basic service sets (BSSs) corresponding to the TWT schedule. For example, the count field may be provided as or similar to the BSS count subfield 820 of FIG. 8. In some embodiments, the second IE includes a field indicating whether a list of BSSs are included in the second IE. For example, the field may be provided as or similar to the BSS list flag 824 of FIG. 8. In some embodiments, the second IE includes a field indicating a list of identifiers of the BSSs which correspond to the TWT schedule. For example, the list of identifiers may be provided as or similar to the first BSS subfield 826 or second BSS subfield 828 of FIG. 8 or any further BSS subfields 828. In some embodiments, one or more BSSID may be provided as or similar to the BSSID subfield 718 of FIG. 7.

In some embodiments, AP1 can execute further operations or suboperations prior to, subsequent to, simultaneous with, or interleaved with operation 1302, operation 1304, or operation 1306. For example, in some embodiments, subsequent to operation 1306, the AP1 can receive a third IE from AP2, the third IE including information indicating a TWT schedule of the AP2. AP1 can transmit one or more signals indicating the TWT schedule of AP2 to a service set (SS) of AP1, based on the third IE.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
advertising, by a first access point (AP), a first information element (IE) indicating a target wake time (TWT) schedule capability of the first AP;
receiving, by the first AP, from a second AP, a request to establish a TWT schedule coordination agreement according to the TWT schedule capability of the first AP; and
transmitting, by the first AP, a second IE to the second AP, the second IE including information indicating a TWT schedule of the first AP.

2. The method of claim 1, wherein the first IE indicates a level of coordination selected from a plurality of levels of coordination, and wherein the request received from the second AP is according to the level of coordination indicated in the first IE.

3. The method of claim 2, wherein the plurality of levels of coordination comprise a first level of coordination corresponding to a scheduling announcement, a second level of coordination corresponding to scheduling alignment, and a third level of coordination corresponding to joint scheduling, and wherein the request received from the second AP is either at the level of coordination indicated by the first IE or at a different level below the level of coordination.

4. The method of claim 1, further comprising:
receiving, by the first AP, a third IE from the second AP, the third IE including information indicating a TWT schedule of the second AP; and
transmitting, by the first AP, to a service set (SS) of the first AP, one or more signals indicating the TWT schedule of the second AP.

5. The method of claim 1, wherein the first AP and the second AP are a group of APs, and wherein one of the first AP or the second AP comprises a group owner AP, and a remainder of the group of APs comprise group member APs.

6. The method of claim 1, wherein the second IE includes a first field for a schedule type for the TWT schedule and a second field for coordination information corresponding to the TWT schedule capability.

7. The method of claim 1, wherein the second IE includes a field indicating a count of basic service sets (BSSs) corresponding to the TWT schedule.

8. The method of claim 7, wherein the field comprises a first field, wherein the second IE includes a second field indicating whether a list of BSSs are included in the second IE, and wherein the second IE further includes, according to a value of the second field, a third field including a list of identifiers corresponding to each of the BSSs which correspond to the TWT schedule.

9. The method of claim 1, wherein the second IE comprises a TWT element including a subfield which indicates whether the TWT element is for establishing the TWT schedule of the first AP, or for schedule coordination between the first AP and the second AP.

10. The method of claim 1, wherein the second IE is included in a TWT schedule coordination frame including a category field, an action field, and the second IE.

11. A first access point (AP), comprising:
a wireless transceiver; and
one or more processors configured to:
advertise a first information element (IE) indicating a target wake time (TWT) schedule capability of the first AP;
receive, from a second AP, a request to establish a TWT schedule coordination agreement according to the TWT schedule capability of the first AP; and
transmit a second IE to the second AP, the second IE including information indicating a TWT schedule of the first AP.

12. The first access point of claim 11, wherein the first IE indicates a level of coordination selected from a plurality of levels of coordination, and wherein the request received from the second AP is according to the level of coordination indicated in the first IE.

13. The first access point of claim 12, wherein the plurality of levels of coordination comprise a first level of coordination corresponding to a scheduling announcement, a second level of coordination corresponding to scheduling alignment, and a third level of coordination corresponding to joint scheduling, and wherein the request received from the second AP is either at the level of coordination indicated by the first IE or at a different level below the level of coordination.

14. The first access point of claim 11, wherein the one or more processors are configured to:
receive a third IE from the second AP, the third IE including information indicating a TWT schedule of the second AP; and
transmit, to a service set (SS) of the first AP, one or more signals indicating the TWT schedule of the second AP.

15. The first access point of claim 11, wherein the first AP and the second AP are a group of APs, and wherein one of the first AP or the second AP comprises a group owner AP, and a remainder of the group of APs comprise group member APs.

16. The first access point of claim 11, wherein the second IE includes a first field for a schedule type for the TWT schedule and a second field for coordination information corresponding to the TWT schedule capability.

17. The first access point of claim 11, wherein the second IE includes a field indicating a count of basic service sets (BSSs) corresponding to the TWT schedule.

18. The first access point of claim 17, wherein the field comprises a first field, wherein the second IE includes a second field indicating whether a list of BSSs are included in the second IE, and wherein the second IE further includes, according to a value of the second field, a third field including a list of identifiers corresponding to each of the BSSs which correspond to the TWT schedule.

19. The first access point of claim 11, wherein the second IE comprises a TWT element including a subfield which indicates whether the TWT element is for establishing the TWT schedule of the first AP, or for schedule coordination between the first AP and the second AP.

20. A first access point (AP), comprising:
a wireless transceiver; and
one or more processors configured to:
receive an advertisement of a first information element (IE) indicating a target wake time (TWT) schedule capability of a second AP;
transmit to the second AP, responsive to the receipt of the first information element (IE), a request to establish a TWT schedule coordination agreement according to the TWT schedule capability of the second AP; and
receive a second IE from the second AP, the second IE including information indicating a TWT schedule of the second AP.
